(19) United States
(12) Patent Application Publication
(10) Pub. No.: US 2011/0036656 A1
(43) Pub. Date: Feb. 17, 2011

(54) Electric Front Wheel Drive System for Motorcycle

(76) Inventor: Reginald Leonard Nicoson, Windsor, CO (US)

Correspondence Address: Reginald Leonard Nicoson, 1135 Osprey Ct., Windsor, CO, 80550, US

(21) Appl. No.: 12/539,756

(22) Filed: Aug. 12, 2009

(51) Int. Cl. B62M 7/00

(52) U.S. Cl. 180/220

(57) ABSTRACT

A two-wheel drive motorcycle having an electric motor driving the front wheel, an embodiment of the present invention, in addition to a conventional rear wheel drive train. The front wheel drive disclosed herein may be adapted to conventional telescoping (or shock-absorbing) front fork suspension systems. The front wheel drive of the two-wheel drive motorcycle may be applied to a number of different types of motorcycles including motocross, enduro, dual-sport and touring motorcycles.

### BACKGROUND OF THE INVENTION

The present invention relates to motorcycles, and more particularly, is related to an electric front wheel drive system for a motorcycle.

It is known and accepted that a motorcycle with a front wheel drive system, which supplements the conventional rear wheel drive, would have improved traction, thus better acceleration and handling performance on any surface condition.

Several patents on front wheel drive or all-wheel drive systems for motorcycles exist. However, all existing systems are mechanical in nature, either by linkage or hydraulics. Specifically, previous patents or attempts at constructing a front wheel drive system have utilized hydraulic, or variations of a belt, shaft or chain drive to transmit power from the rear wheel drive train to the front wheel. U.S. Pat. No. 7,487,854 shows a two-wheel drive motorcycle having a drive train that supplies power to the front wheel using a series of rigid shafts or other internalized drive gears. U.S. Pat. No. 5,894,903 shows an all wheel drive motorcycle using a hydraulic pump and hydraulic motor.

To the applicant's knowledge there is not an electric front wheel drive system for motorcycles. That is, a system that drives the front wheel with an electric motor independent of the rear wheel drive train.

### DESCRIPTION OF THE DRAWINGS

FIG. 1 is a schematic illustrating a motorcycle that an embodiment of the present invention may operate.

FIG. 2 is a block diagram illustrating the components that comprise an electric front wheel drive system.

FIG. 3 is a control block diagram illustrating a control strategy of an electric front wheel drive system.

FIG. 4 is a schematic illustrating an alternate embodiment of this invention.

### DETAILED DESCRIPTION OF THE INVENTION

The following detailed description of preferred embodiments refers to the accompanying drawings, which illustrate specific embodiments of the invention. Other embodiments having different structures and operations do not depart from the scope of the present invention.

The present invention may be applied to motorcycles used in a wide variety of applications including, but not limiting of, motocross, enduro, dual-sport, touring, and the like. An embodiment of the present invention takes the form of an application, product and or method that may incorporate advanced controls, sensors, batteries, and a light-weight electric motor.

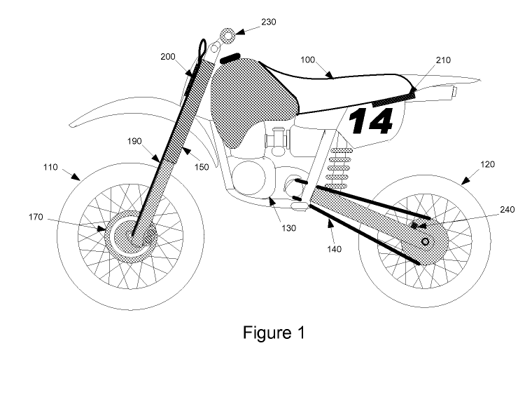

Referring to FIG. 1, there is illustrated a motorcycle 100, which includes a front wheel 110, and a rear wheel 120. The rear wheel 120 is driven by an internal combustion engine 130 or other means through a drive chain 140. The front wheel 110 is mounted to the telescoping fork 150 suspension.

The front wheel 110 included in the embodiment of this invention comprises an electric motor integrated into the hub, hereafter referred to as electric motor 170. The motor stator is fixed to the wheel axle and the rotor is connected to the wheel rim by spokes or other means. The electric motor is a high efficiency, light-weight brushless type motor. The motor cable 190 is routed through the wheel axle. The cap on the end of the axle locks the axle in place to prevent it from rotating due to motor torque. The motor cable has a rigid protective sheath that guides it up the telescoping fork 150 to the controller. The brake disk will mount to the electric motor 170. It should be clarified that brake caliper and front wheel mounting or supporting structures may be integrated or arranged in various ways. The operation of the motorcycle's conventional front fork suspension and brakes is not affected by the electric front wheel drive system.

The controller 200 included in the embodiment of this invention is typically mounted high on the telescoping forks 150 near the motorcycle handle bars.

The energy used by the front wheel drive system is supplied from an energy storage device comprised of a battery or hybrid battery, hereafter referred to as battery 210. The battery 210 included in the embodiment of this invention is typically mounted near the rear of the motorcycle.

Driver front brake controls and throttle controls 230 comprise some of the inputs to the controller. These controls are typically mounted on the handle bars.

The rear wheel speed sensor 240 included in the embodiment of this invention is typically mounted on or near the rear wheel chain drive.

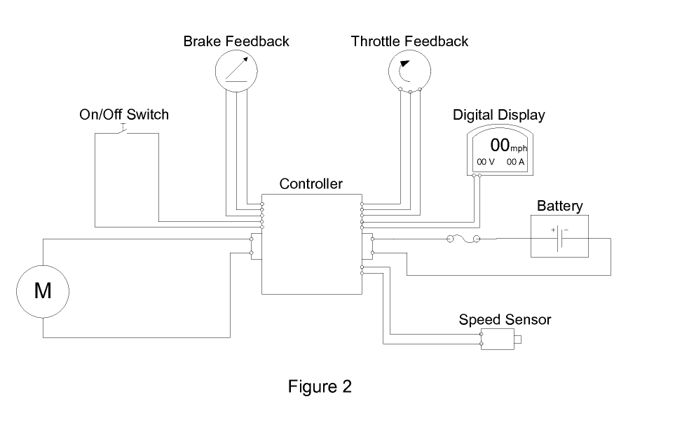

Referring now to FIG. 2, the schematic diagram illustrates the electrical architecture, a possible implementation of an electric front wheel drive system. In the present invention the controller 200 may receive a plurality of signals not limited to motor position and speed, rear wheel speed, throttle demand (position), brake demand (position and or pressure), acceleration, volts, amps, driver inputs to an instrument panel, or the like. The controller is a digital control system, with hardware and software aspects, which control the electric motor.

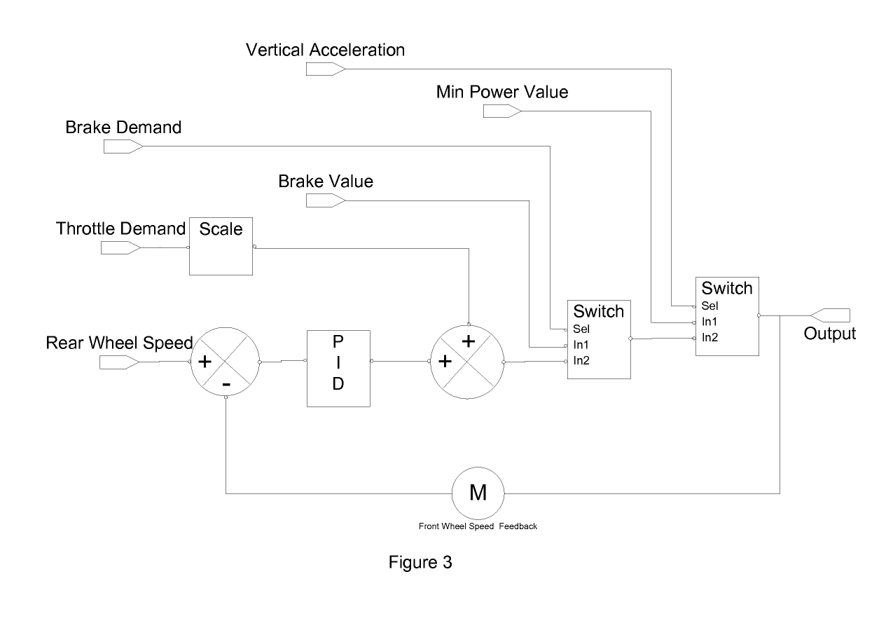

Now referring to FIG. 3, the controller constantly adjusts the motor's output to reduce rear wheel slip, assist braking, recharge the battery, and reduce the front wheel's “flywheel” effect. The control algorithms that comprise the embodiment of this invention take the form of software and or firmware inside the controller. For the purpose of this specification, slip is the difference between rear wheel speed and front wheel speed. If the slip increases or the driver increases the throttle demand, the controller will increase the output to the electric motor proportionally. The reverse is true for a decrease in slip or throttle demand. When rotational speed of the rear wheel is within 1%-2% of the front wheel no power is delivered to the electric motor. When the driver releases the throttle and or applies the front brake the controller uses the motor as a generator to slow the motorcycle, plus recharge the battery. The flywheel effect from accelerating a motorcycle's front wheel while airborne can be dangerous for an unfamiliar rider. This invention may reduce or eliminate the flywheel effect by using accelerometers to detect when the motorcycle has left the ground (vertical acceleration), then reducing power to the front wheel electric motor.

The electric front wheel drive system is designed to have an unlimited range under most driving conditions, for the battery can be recharged in many ways, including but not limited to, a plug-in wall charger, the motorcycles native alternator (if available), re-generative braking, or parasitic charging. The plug-in wall charger is just for topping off the battery before leaving home. The motorcycles native battery charging system can help by providing a small charging current anytime the motorcycle's engine is running. Re-generative braking can provide large charging currents anytime the motorcycle's front wheel brakes are applied, by the front electric motor operating as a generator. The amount of charge current will be proportional to the braking demand. Lastly, parasitic charging is provided to charge the system battery if the charge level falls below the normal operating range. Parasitic charging uses the electric motor as a generator while traveling at steady speeds or coasting (no throttle demand). Referring to FIG. 3, a zero or negative number for the control output indicates the motor is acting as a generator.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, operations, elements, and/or components, but do not preclude the presence or addition of one or more other features, operations, elements, components, and/or groups thereof.

Although specific embodiments have been illustrated and described herein, it should be appreciated that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

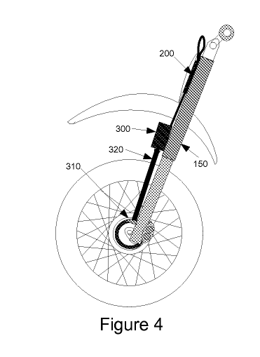

Referring to FIG. 4, an alternate embodiment of this invention consists of electric motors 300 mounted on the upper stationary portion of the front telescoping forks. Power is transmitted to the front wheel hub 310, by mating gears connected to both the lower end of telescoping spline shafts 320 and the hub. The spline shafts are rigidly connected to the electric motors 300 at the upper end.

What is claimed is:

1. An electric powered front wheel drive system for a motorcycle having a conventional or other rear wheel drive train, comprising:
an electric motor integrated into the front wheel hub;
said electric motor's wires (cable) are routed up the front suspension forks to a controller mounted near the front of the motorcycle;
said controller comprises hardware and software which receives feedback signals from many sensors, receives power from a battery, and outputs power to the electric motor;
said controller receives power from a battery near the rear of the motorcycle.

2. The front wheel drive system for a motorcycle defined in claim 1, wherein said controller's feedback signals from sensors may include, but are not limited to, throttle demand (position), front brake demand (position or pressure), rear wheel speed, volts, amps, or driver inputs to an instrument panel.

3. The front wheel drive system for a motorcycle defined in claim 1, wherein said controller regulates the power to the electric motor based on rear wheel slip, and or throttle demand, and or brake demand.

4. The front wheel drive system for a motorcycle defined in claim 1, wherein said controller may reduce or eliminate the fly-wheel effect by using accelerometers to detect when the motorcycle has left the ground (now airborne), then reducing power to the front wheel electric motor.

5. The front wheel drive system for a motorcycle defined in claim 1, wherein said electric motor can act as a generator to re-charge the battery under multiple driving conditions, including but not limited to, braking, coasting, and steady high speeds.

6. The front wheel drive system for a motorcycle defined in claim 1, wherein said battery is not limited to traditional chemical type batteries, but may be a hybrid chemical and super capacitor battery.

7. An alternate embodiment of the invention defined in claim 1, wherein one or two electric motors are mounted on the upper stationary portion of the front telescoping forks. Power is transmitted to the front wheel hub, by mating gears and telescoping spline shafts.
